(19) United States
(12) Patent Application Publication
(10) Pub. No.: US 2026/0284553 A1
(43) Pub. Date: Sep. 24, 2026

(54) COOLANT RECYCLING APPARATUS

(71) Applicant: Camco Manufacturing Inc., Sayre, PA (US)

(72) Inventors: Richard Arnold, Sayre, PA (US); Michael Nickels, Sayre, PA (US); Brandon Clark, Sayre, PA (US); Ryleigh Shedden, Sayre, PA (US); Wasiu Kareem, Sayre, PA (US); Michael Lubertowicz, Sayre, PA (US)

(73) Assignee: Camco Manufacturing Inc., Sayre, PA (US)

(21) Appl. No.: 19/088,012

(22) Filed: Mar. 24, 2025

(51) Int. Cl. B01D 17/02; B01D 17/12

(52) U.S. Cl. CPC B01D 17/0211; B01D 17/0214; B01D 17/12

(57) ABSTRACT

The disclosure provides a coolant recycling apparatus to separate a coolant from an emulsion or a mixture of tramp oil and coolant. The coolant recycling apparatus comprises a container defined by adjoining one or more plates to form a structurally integral unit, a skimmer positioned atop the container to collect a mixture of a coolant and an oil within the container, an elongated separation baffle connected within the container and extends to a bottom of the container, and a spout connected to the separation baffle to discharge out the separated coolant from the bottom of the container. The coolant and the oil separate within the container based on a difference in the buoyancy of the coolant and the oil. Further, the separation baffle is connected to collect the separated coolant at the bottom of the container.

### TECHNICAL FIELD

The present invention relates to the field of coolant recycling from an emulsion. Specifically, the invention pertains to an apparatus used to recycle coolant from an oil that mixes with the coolant during metal cutting operation in industrial cutting equipment, i.e. CNC machines.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The efficient separation of tramp oil from coolant in industrial processes has been a longstanding challenge, with implications for the longevity and performance of machinery and equipment. Tramp oil, comprising oils, greases, and other contaminants, often infiltrates and mingles with the coolant used in machining and metalworking operations. This contamination not only compromises the quality of the coolant but also poses a risk to the effectiveness of manufacturing processes and the machinery involved.

Various methods and systems have been proposed to address the issue of tramp oil contamination in coolant. These methods traditionally involve the use of physical separation techniques, such as gravity separation, coalescence, or filtration. However, the effectiveness of these approaches has been limited, particularly in achieving prominent levels of coolant recycling without necessitating frequent and time-consuming maintenance.

Furthermore, some existing solutions advocate the deployment of dedicated tramp coolant separation units for individual machines or manufacturing stations. While these units can be effective in mitigating contamination, they introduce significant challenges in terms of cost, space utilization, and operational interruptions. Routine maintenance activities, such as cleaning and filter replacement, are often mandated for these standalone units, which, in turn, require the shutdown of machines during non-operational hours. Further, such standalone units require manual intervention and control to turn on or off from time to time.

In light of these limitations, there exists a need for an innovative and improved solution that effectively separates tramp oil from coolant in an efficient and cost-effective manner, while also minimizing the associated maintenance and operational disruptions.

### SUMMARY

Before the present system and its components are described, it is to be understood that this disclosure is not limited to the particular system and its arrangement as described, as there can be multiple possible embodiments that are not expressly illustrated in the present disclosure. It is also to be understood that the terminology used in the description is for the purpose of describing the particular versions or embodiments only and is not intended to limit the scope of the present application. This summary is not intended to identify essential features of the claimed subject matter nor is it intended for use in detecting or limiting the scope of the claimed subject matter.

The present disclosure relates to a coolant recycling apparatus. The coolant recycling apparatus may comprise a container defined by adjoining one or more plates to form a structurally integral unit. The coolant recycling apparatus may comprise a tube skimmer positioned atop the container to collect a mixture of coolant and oil within the container. The container is configured as a coolant reclaim tank for the collection of the mixture and for the separation of the coolant from the mixture. Once the mixture is collected in the container by the skimmer, the coolant and the oil separate within the container based on a difference in the buoyancy of the coolant and the oil. Further, the coolant recycling apparatus further comprises an elongated separation baffle connected within the container and extends to a bottom of the container. The separation baffle may be connected to collect the separated coolant at the bottom of the container. Further, the coolant recycling apparatus may comprise a spout connected to the separation baffle to discharge out the separated coolant from the bottom of the container.

### BRIEF DESCRIPTION OF FIGURES

The detailed description is described with reference to the accompanying Figures. In the Figures, the left-most digit(s) of a reference number identifies the Figure in which the reference number first appears. The same numbers are used throughout the drawings to refer to like features and components.

FIG. 1 illustrates a perspective view of the coolant recycling apparatus, according to a first embodiment of the present disclosure.

FIG. 2 illustrates a perspective view of the coolant recycling apparatus, according to a second embodiment of the present disclosure.

FIG. 3 illustrates a rear view of the coolant recycling apparatus as shown in FIG. 2, according to the second embodiment of the present disclosure.

FIG. 4 illustrates a view of the coolant recycling apparatus as shown in FIG. 2 without a side wall, according to the second embodiment of the present disclosure.

FIG. 5 illustrates a perspective view of the coolant recycling apparatus connected to an oil tank of a CNC machine, according to an embodiment of the present disclosure.

### DETAILED DESCRIPTION

Before the present apparatus and its components are described, it is to be understood that this disclosure is not limited to the particular apparatus and its arrangement as described, as there can be multiple possible embodiments that are not expressly illustrated in the present disclosure. It is also to be understood that the terminology used in the description is for the purpose of describing the particular versions or embodiments only and is not intended to limit the scope of the present application. This summary is not intended to identify essential features of the claimed subject matter nor is it intended for use in detecting or limiting the scope of the claimed subject matter.

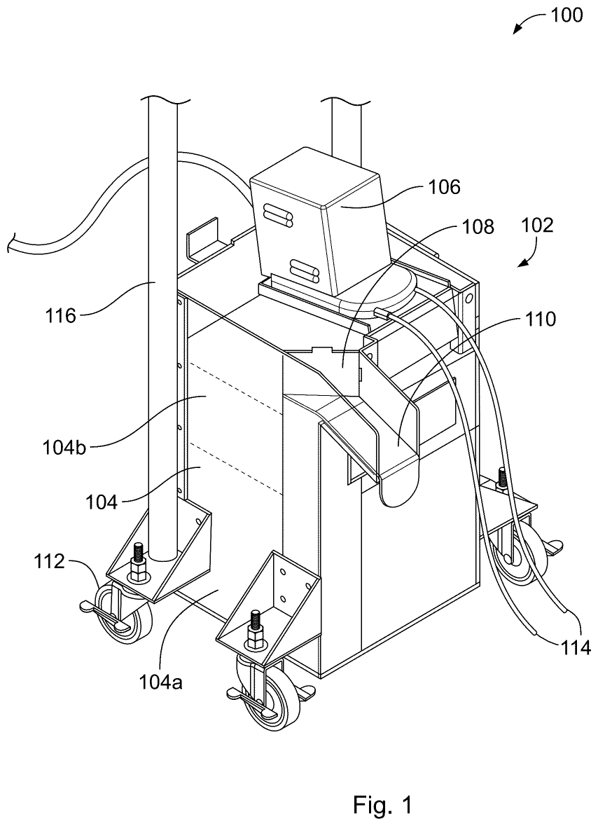

FIG. 1 illustrates a perspective view 100 of the coolant recycling apparatus 102, according to a first embodiment of the present disclosure.

Referring to FIG. 1, the coolant recycling apparatus 102 may comprise a container 104, a skimmer 106 connected to the container 104, and a supply hose 114 connected to the skimmer 106. Further, the coolant recycling apparatus 102 may comprise an elongated separation baffle 108 connected within the container 104. The separation baffle 108 extends to a bottom of the container 104 and is configured to collect a coolant 104a from a bottom of the container 104. In one embodiment, a coolant exit spout 110 may be connected to the separation baffle 108 to discharge the separate coolant 104a from the emulsion at the bottom of the container 104. In another embodiment, the coolant exit spout 110 may be connected to the container 104 at a top end of the separation baffle 108 to discharge the separated coolant 104a. The container 104 may be defined by adjoining one or more plates to form a structurally integral container body.

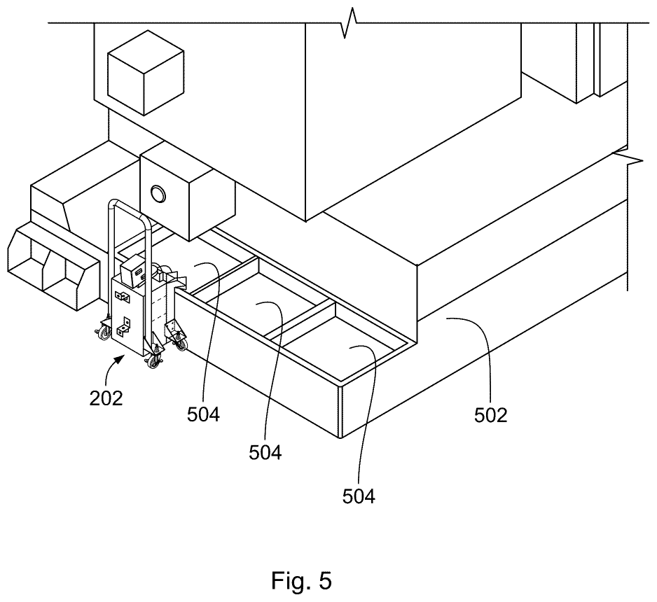

In an embodiment, the skimmer 106 may be fluidically connected to the container 104. In an embodiment, the skimmer 106 may be connected to a coolant reclaim tank 504 of any industrial device, such as a CNC machine 502, as shown in FIG. 5, or any equipment known in the art that may require an emulsion of coolant 104a and oil 104b. In an embodiment, the skimmer 106 may be configured to draw emulsion of coolant 104a and oil 104b to the container 104, using the supply hose 114. The skimmer 106 may be at least a disk skimmer, weir skimmer, oil skimmer, belt oil skimmer, bucket skimmer, oleophilic skimmer, suction skimmer, or belt skimmer.

In an embodiment, the skimmer 106 is configured to draw and collect the emulsion of the coolant 104a and 104b from one or more coolant reclaim tank504 of the CNC machine 502, via the supply hose 114, as shown in FIG. 5 and described later in this paper. Within the container, due to intrinsic properties of fluid such as buoyancy and a density corresponding thereto, the coolant 104a and the oil 104b may separate accordingly. The emulsion separated may be illustrated as coolant 104a, and oil 104b (refer to FIGS. 1-3). Coolant 104a being denser as compared to oil 104b may settle downwards in the container 104. Particularly, when the emulsion may be collected by the skimmer 106 within the container 104, after a predefined time, the coolant 104a may settle downwards therein, and the oil 104b may float on the top of the coolant 104a. Hence, the coolant 104a may be separated from the oil 104b.

Referring to FIG. 1, the separation baffle 108 is connected to the container 104. The separation baffle 108 may be formed by connecting a plate on at least one inner corner of the container 104. The plate extends from near a top to the bottom of the container 104. The plate forms a channel at the corner and includes an opening near the bottom of the container 104 for the separated coolant 104a to draw out of the container 104 through the separation baffle 108. In one embodiment, the plate of the separate baffle 108 may include one or more apertures (not shown) to draw out the coolant 104a from the bottom of the container 104.

Further, the spout 110 may be formed within the container 104 at a top end of the separation baffle 108 to discharge the coolant 104a out of the container 104. The spout 110 may be connected within a side plate of the container 104 within an opening at the top end of the separation baffle 108.

In another embodiment, the spout 110 may be formed as a channel within the side plate of the container 104.

In an embodiment, the container 104 may be fabricated from 12-gauge steel, with a thickness of 0.105 inches (0.267 centimeters). This steel construction not only ensures durability but also facilitates cost-effective manufacturing

The coolant recycling apparatus 102 may be further integrated with various features to enhance usability and functionality. For instance, the coolant recycling apparatus 102 may include one or more wheels 112 and a handle 116, primarily to simplify the transport of the coolant recycling apparatus 102.

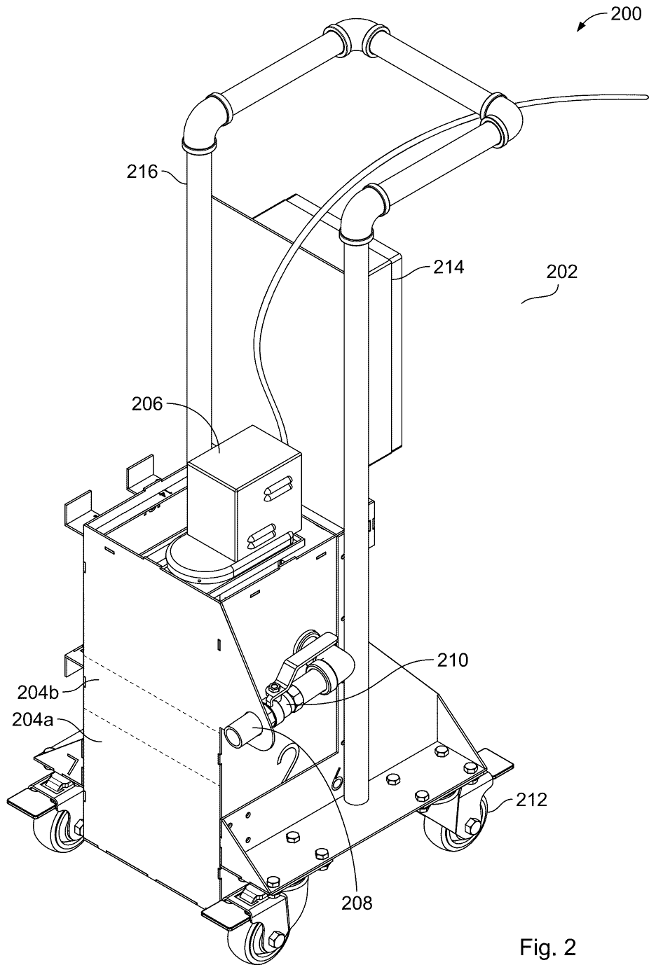

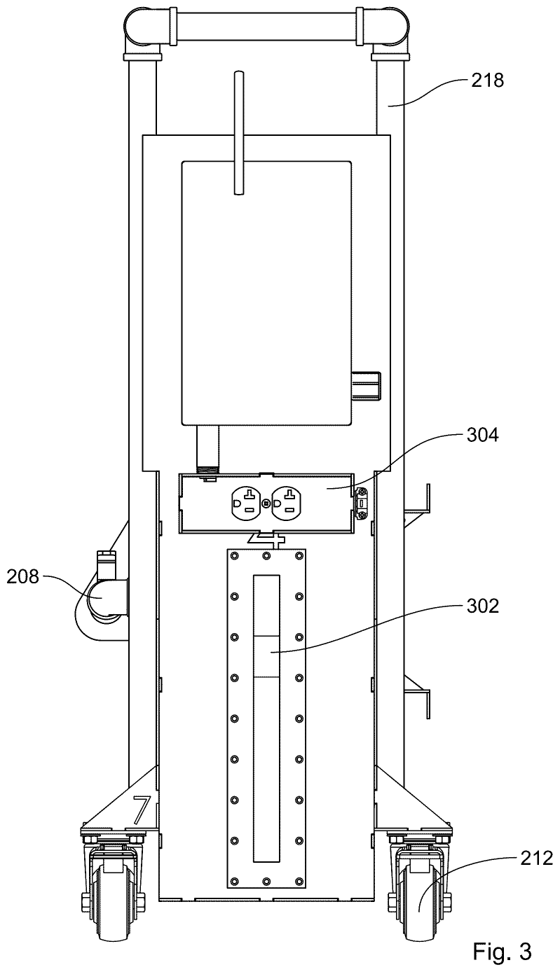

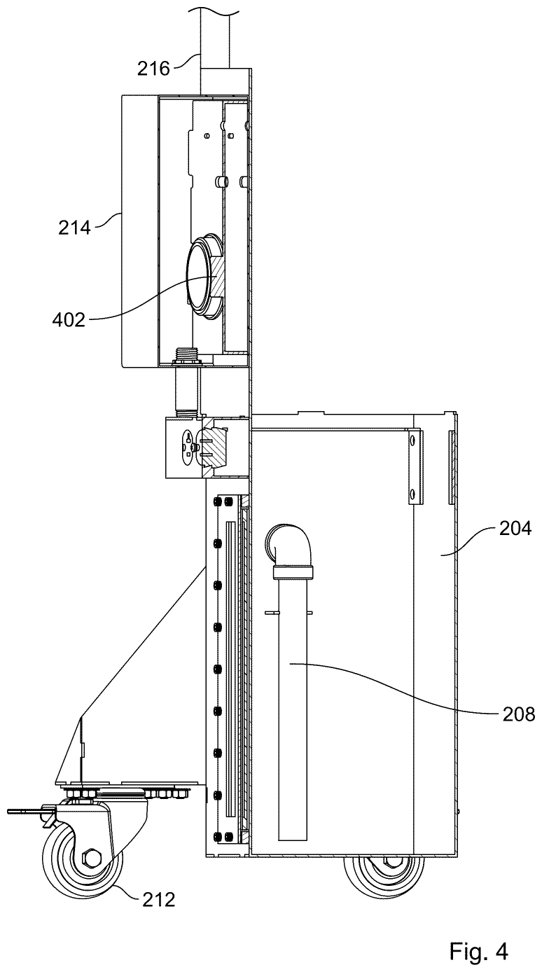

FIG. 2 illustrates a perspective view 200 of the coolant recycling apparatus 202, according to a second embodiment of the present disclosure. FIG. 3 illustrates a rear view of the coolant recycling apparatus 202 as shown in FIG. 2, according to the second embodiment of the present disclosure. FIG. 4 illustrates a view of the coolant recycling apparatus as shown in FIG. 2 without a side wall, according to the second embodiment of the present disclosure.

Referring to FIG. 2 and FIG. 3, the coolant recycling apparatus 202 may comprise a container 204 defined by adjoining one or more side plates to form a structurally integral container body. The coolant recycling apparatus 202 may further comprise a skimmer 206 connected to the container 204, an elongated separation baffle 208 connected to the container 204, and a spout 210 connected to the separation baffle 208. The coolant recycling apparatus 202 may further comprise one or more wheels 212 and a handle 216 connected to the container 204. Further, the coolant recycling apparatus 202 may include a timer control unit 218 electrically connected to the skimmer 206 to control the functioning time of the skimmer 206 and reduce unnecessary skimmer wear.

The skimmer 206 may be fluidically connected to the container 204. In an embodiment, the skimmer 206 may be connected to an oil unit of any industrial device, such as a CNC machine 502, as shown in FIG. 5, or any equipment known in the art that may require an emulsion of oil and coolant. In an embodiment, the skimmer 206 may be configured to draw emulsion of coolant 204a and oil 204b to the container 204, using the supply hose (not shown), similar to the supply hose 114 as shown in the embodiment of FIG. 1.

Due to the intrinsic properties of fluid such as buoyancy and a density corresponding thereto, the oil and coolant may separate accordingly. The coolant 204a being denser as compared to oil 204b may settle downwards in the container 204. Particularly, when the emulsion may be collected by the skimmer 206 within the container 204, after a predefined time, the coolant 204aa may settle downwards therein, and the oil 204b may float atop the coolant 204a. Hence, the coolant 204a may be separated from the oil 204b at a bottom of the container 204.

The separation baffle 208 may be connected within the container 204 to discharge out the separated coolant 204a. The separation baffle 208 may be a pipe baffle. In an embodiment, the separation baffle 208 may be connected with a top opening of the separation baffle 208 emerging out of at least one side wall of the container 204, while, the opposite bottom opening extends towards the bottom of the container 204, as shown in FIG. 4. The bottom opening of the separation baffle 208 extends to an inner bottom surface of the container 204, but does not touch the inner bottom surface (please refer FIG. 4) to enable the separated coolant 204a to enter into the separation baffle 208.

Further, the top opening of the separation baffle 208 may emerge out from approximately a middle of the side wall. In another embodiment, the top opening of the separation baffle 208 may emerge from any location on at least one of the side walls of the container 204. Accordingly, an increase in a height of a mixture or emulsion within the container 204 above the top opening of the separation baffle 208 may cause the separated coolant 204a to discharge out due to the gravitational force.

In an embodiment, a spout 210 may be connected to the top opening of the separation baffle 208 through a control valve 214. The control valve 214 may be configured for manual control of the flow during the settlement of the emulsion and separation of the coolant 204a.

In an embodiment, the coolant recycling apparatus 102 may be integrated with various features to enhance usability and functionality. In an embodiment, the coolant recycling apparatus 202 may be equipped with a cord hanger, which, while not indispensable to the primary function of the coolant recycling apparatus 102, aids in the organized management of the skimmer's wire, ensuring it remains out of the way during operation and transport. Furthermore, to the coolant recycling apparatus 202, optional wheels 212 and a handle 216 may be incorporated, primarily to simplify transport. These additions, while not essential for the core function of the coolant recycling apparatus 202, may contribute significantly to its mobility, particularly in larger industrial settings. In an embodiment, the coolant recycling apparatus 202 may include a sight glass 302, which may provide users with a visual means of assessing the ratio of coolant 204a to oil 204b within the container 204. Additionally, one or more electric sockets 304 connected to the skimmer 206 may be provided to connect an external power supply for the functioning of the skimmer 206 and other electronic equipment of the coolant recycling apparatus 202.

In an embodiment, the timer unit 402, as shown in FIG. 4, may be connected to the coolant recycling apparatus 202. The timer unit 402 may be connected to the skimmer 206 to control the functioning time of the skimmer 206 and avoid overflowing of the container 202 as well as reduce unnecessary skimmer wear.

FIG. 5 illustrates a perspective view of the coolant recycling apparatus 202 connected to an oil tank of a CNC machine, according to an embodiment of the present disclosure.

Referring to FIG. 5, the coolant recycling apparatus 202 may be used for any industrial machine that uses an emulsion of the coolant and oil such as a CNC machine 502. The coolant recycling apparatus 202 may draw the emulsion of the coolant and oil from one or more collecting tanks 504 of the machine 502 through the supply hose 114 as shown in FIG. 1.

In an embodiment, the coolant recycling apparatus 202 is tailored to serve multiple machines efficiently. Specifically, the coolant recycling apparatus 202 may be designed to accommodate and support the operational needs of up to 20 machines within a 30-day cycle, utilizing a single unit. This unique adaptability presents a substantial advantage by minimizing capital expenditures for end-users, streamlining their operations, and significantly reducing the overall environmental impact of coolant management systems.

In another embodiment, the coolant recycling apparatus 202 may be designed as a space-efficient design, making it exceptionally suitable for integration into various industrial settings. The compactness of the coolant recycling apparatus 202 may ensure that a minimal floor space may be required during installation. This attribute facilitates the seamless incorporation of the coolant recycling apparatus 202 into diverse working environments and may allow users to maximize their available workspace efficiently.

In an embodiment, the coolant recycling apparatus 202 minimizes downtime and maintenance expenses through a simple design. Notably, the coolant recycling apparatus 202 necessitates a complete cleaning cycle only once per year, representing a significant reduction in maintenance-related interruptions compared to existing systems. Such advantages ensure that the unit maintains its structural integrity and operational efficiency even during prolonged periods of use.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples, and alternatives of the preceding paragraphs or the description and drawings, including any of their various aspects or respective individual features, may be taken independently or in any combination. Features described in connection with one embodiment are applicable to all embodiments unless such features are incompatible.

What is claimed is:

1. A coolant recycling apparatus, comprising:
a container defined by adjoining one or more plates to form a structurally integral unit;
a skimmer positioned atop the container to collect a mixture of a coolant and an oil within the container, wherein the coolant and the oil separate within the container based on a difference in buoyancy of the coolant and the oil;
an elongated separation baffle connected within the container and extending to a bottom of the container, wherein the elongated separation baffle is connected to collect separated coolant at the bottom of the container; and
a spout connected to the elongated separation baffle to discharge out the separated coolant from the bottom of the container.

2. The coolant recycling apparatus as claimed in claim 1, wherein
the elongated separation baffle is connected to at least one of the one or more plates and includes an opening at a first end, wherein the first end extends to the bottom of the container; and
the spout is connected to a second end, opposite to the first end, of the elongated separation baffle.

3. The coolant recycling apparatus as claimed in claim 1, wherein the elongated separation baffle is formed by an elongated plate connected to at least one internal corner and extended to the bottom of the container.

4. The coolant recycling apparatus as claimed in claim 2, wherein each of the one or more plates includes an opening at the bottom of the container for collection of the separated coolant from the bottom of the container.

5. The coolant recycling apparatus of claim 1, wherein the elongated separation baffle is a pipe baffle connected within the container.

6. The coolant recycling apparatus of claim 1 further comprises one or more wheels connected to the bottom of the container, wherein the one or more wheels are connected at an outer surface of the container.

7. The coolant recycling apparatus of claim 1, wherein the skimmer is configured to collect the mixture into the container.

8. The coolant recycling apparatus of claim 1 further comprises a timer connected to the skimmer to control a time of functioning of the skimmer.

9. The coolant recycling apparatus of claim 1 further comprises a handle frame for a motion control of the coolant recycling apparatus.

10. The coolant recycling apparatus as claimed in claim 1, wherein the separation of coolant and oil is facilitated by the difference in the buoyancy of the coolant and the oil, without a requirement of external energy sources or mechanical processes.
